(19) United States
(12) Patent Application Publication
(10) Pub. No.: US 2021/0138602 A1
(43) Pub. Date: May 13, 2021

(54) Wood Router Support Device

(71) Applicant: Harold Metcalfe, Franklin, IN (US)

(72) Inventor: Harold Metcalfe, Franklin, IN (US)

(21) Appl. No.: 16/747,050

(22) Filed: Jan. 20, 2020

Related U.S. Application Data
(60) Provisional application No. 62/933,601, filed on Nov. 11, 2019.

(51) Int. Cl. B23Q 17/22; B27C 5/10

(52) U.S. Cl. CPC B23Q 17/2233; B23Q 2717/006; B27C 5/10

(57) ABSTRACT

A wood router support device including a base board having a measurement stick attached to the base board. The base board has a router attachment located at one end and a slot beginning at the router attachment and running longitudinally to the opposite end. The measurement stick is slidably attached to the base board using a tongue and groove attachment. The tongue is part of the base board and is configured to fit within the groove located within the measuring stick. The measuring stick has an aperture located in an end closed to the router attachment. The aperture rotatably accepts an attachment device therein.

### CROSS REFERENCE TO RELATED APPLICATIONS

This application claims the benefit of U.S. Provisional Application No. 62/933,601 filed on Nov. 11, 2019. The above identified patent application is herein incorporated by reference in its entirety to provide continuity of disclosure.

### BACKGROUND OF THE INVENTION

The present invention relates to using and supporting a router. More particularly, the present invention provides a device to make wood working with a router easier

Routers are a very useful and common tool for wood working activities. Routers can be used for all manners of tasks. Some of these tasks include cutting hole or circles. On some occasions this may be a simple job. However, when attempting to cut a hole or circle with a diameter of less than five inches the process is complicated.

When cutting a hole of this size an individual must first remove the router bit. In some instances, this can mean disassembling part of the router. The guide pin must then be tightened. The individual must then use a tape measure to correctly set the size of the hole. Various tools are used to set the guide pin to this desired length to have the hole correctly cut. The bit then needs returned to the router and in some instances the router reassembled.

Consequently, there is a need in for an improvement in the art of wood working. The present invention substantially diverges in design elements from the known art while at the same time solves a problem many people face when using a router. In this regard the present invention substantially fulfills these needs.

### SUMMARY OF THE INVENTION

The present invention provides a wood router support device wherein the same can be utilized for providing convenience for the user when using a wood router. The wood router support device comprises a base board having a router connection placed at one end. The base board has a slot located longitudinally therein. There is a measurement stick placed within the slot. The slot has a tongue located therein and the measurement stick has a corresponding groove configured to have the tongue fit therein. An aperture is located at one end of the measurement stick closest to the router connection.

Another object of the wood router support device is to have the tongue located on one side of the slot and the groove located on a corresponding side of the measurement stick.

Another object of the wood router support device is to have a second tongue located on a second side of the slot and a second groove located on a second side of the measurement stick.

Another object of the wood router support device is to have a cross member located an end of the base board opposite the router connection.

Another object of the wood router support device is to have a center cross member located across the slot between the end of the base board having the router connection and an opposite end.

Another object of the wood router support device is to have a securement device attached to the center cross member, wherein the securement device is configured to secure the measurement stick in place within the base board.

Another object of the wood router support device is to have a measurement device located in the base board, wherein the measurement device runs along an edge of the slot.

Another object of the wood router support device is to have a second measurement device located in the base board, wherein the second measurement device runs along an edge of the slot.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top down view of an embodiment of the wood router support device.

FIG. 2 shows a perspective view of an embodiment of the wood router support device having a single tongue and groove.

FIG. 3 shows a perspective view of an embodiment of the wood router support device having two tongues and grooves.

FIG. 4 shows a perspective view of an embodiment of the wood router support device having a router attached thereto.

### DETAILED DESCRIPTION OF THE INVENTION

Reference is made herein to the attached drawings. Like reference numerals are used throughout the drawings to depict like or similar elements of the wood router support device. For the purposes of presenting a brief and clear description of the present invention, a preferred embodiment will be discussed as used for the wood router support device. The figures are intended for representative purposes only and should not be considered to be limiting in any respect.

Referring now to FIG. 1, there is shown a top down view of an embodiment of the wood router support device. The router support device is comprised of a base 101. In one embodiment the base 101 is made from wood. In another embodiment the base 101 is made from plastic. In other embodiments other suitable materials are used. The base has a first end 101A and a second end 1011

The base 101 has a channel 102 therein. The channel 102 starts at the second end 1018 and moves toward the first end 101A. The first end 101A of the base 101 is a closed end. This creates an elongated horseshoe shape. The second end 101B of the base 101 has a cross bar 103 placed a crossed the opening. This will add support and prevent the device from being accidentally broken by being pulled apart.

There is at least one measurement device 104, 105 located on at least one side of the channel 102. In one embodiment the measurement device 104 has standard measurement indicia. In the same embodiment measurement device 105 has metric measurement indicia. In another embodiment both measurement devices 104, 105 have the same measurement indicia located thereon.

There is a router connection area 106 located at the first end 101A of the base 101. The router connection area 106 includes a plurality of apertures 107. The apertures 107 are configured to align with a router's connection holes. This will allow the router to be connected easily to the base 101. There is further a router bit opening 108. In one embodiment the router bit opening 108 is located at the end of the channel 102.

Referring now to FIG. 2 and FIG. 3, there are shown perspective views of embodiments of the wood router support device having a single tongue and groove and the device having two tongues and two grooves. The wood router support device includes a measurement insert 203. The measurement insert 203 is configured to be placed within the channel 102 of the base 101. The measurement insert 203 includes a securement hole 206 located at one end. The securement hole 206 is configured to accept a securement device therethrough. In one embodiment the securement device is a screw. This will allow the wood router support device to be connected to a piece of material to be cut. The measurement insert 203 further includes at least one measurement marking 207. The measurement marking 207 is configured to allow a user to determine a measurement using the at least one measurement device 104, 105.

The wood router support device further includes a second cross support 201. The second cross support 201 is located between the first end 101A and the second end 101B of the base 101. The second cross support 201 has a securement device 202 located therethrough. The securement device 202 is configured to secure the measurement insert 203 at a desired length. In one embodiment the securement device 202 is a thumb screw and a bolt. In another embodiment a turn knob attached to a screw and a nut are used. The securement device 202 will apply pressure to the measurement insert 203 and prevent it from moving.

In some embodiments the measurement insert 203 is configured to be slidably attached to the base 101. In one embodiment this is done using a tongue and groove configuration. In one embodiment there is a single tongue 204A located on an interior side of the channel 102. In this embodiment there is a corresponding groove 205A located on an outer edge of the measurement insert 203. In another embodiment there is a tongue 204A, 204B located on each interior side of the channel. In this embodiment there is a corresponding groove 205A, 205B located on both outer edges of the measurement insert 203.

Referring now to FIG. 4, there is shown a perspective view of an embodiment of the wood router support device having a router attached thereto. In use the wood router support device has a router 401 attached to the device. The user moves the measurement insert to the desired distance using the measurement devices 104, 105. Then the securement device 202 is tightened to prevent the measurement insert 203 from moving. The device is then secured to the material to be cut. From there the user may use the device to cut a circle of the desired size.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A wood router support device, the device comprises:
a base board having a router connection placed at one end;
the base board has a slot located longitudinally therein;
there is a measurement stick placed within the slot;
an aperture is located at one end of the measurement stick closest to the router connection.

2. The wood router support device of claim 1, further comprising a cross member located an end of the base board opposite the router connection.

3. The wood router support device of claim 1, further comprising a center cross member located across the slot between the end of the base board having the router connection and an opposite end.

4. The wood router support device of claim 3, further comprising a securement device attached to the center cross member, wherein the securement device is configured to secure the measurement stick in place within the base board.

5. The wood router support device of claim 1, further comprising a measurement device located in the base board, wherein the measurement device runs along an edge of the slot.

6. The wood router support device of claim 5, further comprising a second measurement device located in the base board, wherein the second measurement device runs along an edge of the slot.

7. A wood router support device, the device comprises:
a base board having a router connection placed at one end;
the base board has a slot located longitudinally therein;
there is a measurement stick placed within the slot;
wherein the slot has a tongue located therein and the measurement stick has a corresponding groove configured to have the tongue fit therein;
an aperture is located at one end of the measurement stick closest o the router connection.

8. The wood router support device of claim 7, wherein the tongue is located on one side of the slot and the groove is located on a corresponding side of the measurement stick.

9. The wood router support device of claim 8, further comprising a second tongue located on a second side of the slot and a second groove located on a second side of the measurement stick.

10. The wood router support device of claim 7, further comprising a cross member located an end of the base board opposite the router connection.

11. The wood router support device of claim 7, further comprising a center cross member located across the slot between the end of the base board having the router connection and an opposite end.

12. The wood router support device of claim 11, further comprising a securement device attached to the center cross member, wherein the securement device is configured to secure the measurement stick in place within the base board.

13. The wood router support device of claim 7, further comprising a measurement device located in the base board, wherein the measurement device runs along an edge of the slot.

14. The wood router support device of claim 13, further comprising a second measurement device located in the base board, wherein the second measurement device runs along an edge of the slot.
